(19) United States
(12) Patent Application Publication
(10) Pub. No.: US 2025/0020485 A1
(43) Pub. Date: Jan. 16, 2025

(54) UPDATING BLENDING COEFFICIENTS IN REAL-TIME FOR VIRTUAL OUTPUT OF AN ARRAY OF SENSORS

(71) Applicant: Honeywell International Inc., Charlotte, NC (US)

(72) Inventors: Christopher J. Mauer, Roseville, MN (US); Jens M. Henrickson, West Saint Paul, MN (US); Patrick James Collins, Minneapolis, MN (US)

(73) Assignee: Honeywell International Inc., Charlotte, NC (US)

(21) Appl. No.: 18/352,477

(22) Filed: Jul. 14, 2023

(51) Int. Cl. G01D 1/04; G01C 21/10

(52) U.S. Cl. CPC G01D 1/04; G01C 21/10

(57) ABSTRACT

A method of dynamic, real-time generation of a blended output from a plurality of sensors is provided. The method includes, at a frame rate, periodically storing samples from the plurality of sensors; band pass filtering the stored samples separately for each of the plurality of sensors over a time scale characteristic of a type of error for the plurality of sensors; storing the filtered samples; at an accumulation rate, iteratively updating a covariance matrix based on a selected number of filtered samples, removing data from the covariance matrix for any of the plurality of sensors that have failed; and calculating, based on the covariance matrix, changes to real-time coefficients to be applied to the outputs of each sensor of the plurality of sensors; and at the frame rate, applying the changes to the real-time coefficients; and calculating the blended output for the plurality of sensors based on the real-time coefficients.

### BACKGROUND

An inertial measurement unit (IMU) is an electronic device that measures and reports data on, for example, acceleration, angular rate and orientation of an associated body using a combination of gyroscopes, accelerometers and sometimes magnetometers. IMUs are used in a variety of applications such as inertial navigation systems to provide navigation and control functions for aircraft, missiles, ships, submarines and satellites. Many conventional IMUs are large, expensive and require high power for proper operation.

Lower-grade IMUs have been developed using micro-electromechanical system (MEMS) gyroscopes and accelerometers. These MEMS-based IMUs are smaller, cheaper and operate on less power than conventional IMUs. Such IMUs with MEMS sensors are used extensively in applications that have lower accuracy requirements. For example, IMUs with MEMS sensors are used in most smart phones and tablets to track and report the orientation of the device. Fitness trackers and other wearables include IMUs with MEMS sensors to measure motion such as running or walking.

IMUs with MEMS sensors (gyroscopes and accelerometers) conventionally have had a limited role in Global Navigation Satellite System/Inertial Navigation System (GNSS/INS) integrated navigation due to high measurement noise and unstable performance parameters of MEMS sensors. Thus, conventional GNSS/INS integrated navigation systems have been denied access to the low size, weight and power (SWAP) commonly associated with the use of MEMS sensors.

Thus, there is a need in the art for developing an IMU that leverages the low SWAP associated with MEMS sensors while providing the high-performance characteristics associated with conventional IMUs used in navigation systems.

### SUMMARY

In some aspects, the techniques described herein relate to a method of dynamic, real-time generation of a blended output from a plurality of sensors, the method including: at a frame rate, periodically storing samples of outputs of the plurality of sensors as stored samples; filtering the stored samples separately for each of the plurality of sensors with a bandpass filter over a time scale characteristic of a type of error for the plurality of sensors to produce filtered samples; storing the filtered samples; at an accumulation rate, iteratively updating a covariance matrix based on the filtered samples until a selected number of filtered samples have been processed, removing data from the covariance matrix for any of the plurality of sensors that have failed; and calculating, based on the covariance matrix, changes to real-time coefficients to be applied to the outputs of each sensor of the plurality of sensors; and at the frame rate, applying the changes to the real-time coefficients; and calculating the blended output for the plurality of sensors based on the real-time coefficients.

In some aspects, the techniques described herein relate to an inertial measurement unit (IMU) including: a plurality of micro-electromechanical system sensors (MEMS sensors), each of the plurality of MEMS sensors having an output; a storage medium for storing calibration coefficients separately for each of the plurality of MEMS sensors, real-time coefficients for each of the plurality of MEMS sensors, and data blending instructions for blending the outputs of the plurality of MEMS sensors; and a processor, coupled to the storage medium and the plurality of MEMS sensors, configured to execute program instructions to: filter, at a frame rate, samples output by the plurality of MEMS sensors with a bandpass filter over a time scale characteristic of a type of error for the plurality of MEMS sensors to produce filtered samples; iteratively update a covariance matrix, at an accumulation rate, based on the filtered samples until a selected number of filtered samples have been processed, calculate, based on the covariance matrix, changes to the real-time coefficients to be applied to the output of each MEMS sensor of the plurality of MEMS sensors; apply, at the frame rate, the changes to the real-time coefficients; and calculate a blended output for the plurality of MEMS sensors based on the real-time coefficients.

In some aspects, the techniques described herein relate to a program product including a non-transitory computer-readable medium on which program instructions configured to be executed by at least one processor are embodied, wherein when executed by the at least one processor, the program instructions cause the at least one processor to perform a method including: at a frame rate, periodically storing samples of outputs of a plurality of sensors to produce stored samples; filtering the stored samples separately for each of the plurality of sensors with a bandpass filter over a time scale characteristic of a type of error for the plurality of sensors to produce filtered samples; storing the filtered samples; at an accumulation rate, iteratively updating a covariance matrix based on the filtered samples until a selected number of filtered samples have been processed, removing data from the covariance matrix for any of the plurality of sensors that have failed; and calculating, based on the covariance matrix, changes to real-time coefficients to be applied to the outputs of each sensor of the plurality of sensors; and at the frame rate, applying the changes to the real-time coefficients; and calculating a blended output for the plurality of sensors based on the real-time coefficients.

### BRIEF DESCRIPTION OF THE DRAWINGS

Embodiments of the present invention can be more easily understood and further advantages and uses thereof more readily apparent, when considered in view of the description of the preferred embodiments and the following figures in which:

FIG. 1 is a block diagram of one embodiment of an inertial measurement unit (IMU) that includes an array of micro-electromechanical system (MEMS) sensors that uses blending coefficients, updated in real-time, to blend the outputs of the MEMS sensors to produce a virtual output of the IMU.

FIG. 2 is a flow chart that illustrates one embodiment of a process for filtering the outputs of a plurality of MEMS sensors to produce filtered data for use in calculating real-time changes to blending coefficients and for applying blending coefficients, updated in real-time, to the output of the plurality of MEMS sensors to provide a blended output for the IMU.

FIG. 3 is a flow chart that illustrates one embodiment of a process for calculating updates to blending coefficients in real-time.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof and in which is shown by way of specific illustrative embodiments in which the invention may be practiced. These embodiments are described in sufficient detail to enable those skilled in the art to practice the invention, and it is to be understood that other embodiments may be used and that logical, mechanical and electrical changes may be made without departing from the scope of the present invention. The following detailed description is, therefore, not to be taken in a limiting sense.

Embodiments of the present invention provide an inertial measurement unit (IMU) with low size, weight, and power (SWAP) specifications due to the use of an array of low grade (consumer) micro-electromechanical system (MEMS) sensors. It has been found that an array of N independent MEMS sensors, each with the same measurement error level, can reduce measurement errors of the IMU by approximately the square root of N times by properly fusing or blending the outputs of the N independent MEMS sensors. However, low grade MEMS sensors suffer from issues with reliability (e.g., they are prone to fail prematurely). When low-grade MEMS sensors are used in an array, the statistical chance of a premature failure of a sensor during the expected life of the IMU array becomes greater when the number of sensors increases. Further, there are some very substantial performance benefits of using optimal weight strategies when blending the outputs of the sensors in the array. Embodiments of the present invention address these issues, and thereby improve sensor technology, by dynamically (1) adjusting blending coefficients of the IMU array during operation to effectively remove the impact of failed sensors, and, (2) adapting, in real-time during operation of the IMU array, the coefficients to changing circumstances in the operation of the array of sensors. These coefficients are referred to herein as “real-time coefficients.” This enables the output of a failed sensor to be ignored while the real-time coefficients assigned to functioning sensors are updated dynamically based on current performance of each sensor in the array. In some embodiments, the real-time coefficients are used in conjunction with factory calibrated coefficients (referred to as “calibration coefficients”) dynamically to provide the blended output of the array of sensors. In some embodiments, the calibration coefficients are also updated to effectively remove the impact of failed sensors in calculations that rely on the calibration coefficients as discussed in more detail below.

### Basis for Calculation and Use of Real-Time Coefficients

For real-time coefficients, the optimal coefficient vector is defined as:

$${c}_{0} = {arg min}_{c ∈ {ℛ}^{n}} {c}^{T} P c \qquad ( 1 )$$

in which P is a covariance matrix. This formulation is problematic due to the restriction that the coefficients must sum to 1. In other words:

$${c}^{T} {1}_{n} = 1 \qquad ( 2 )$$

Therefore, using the method of Lagrange multipliers (λ), constraints can be imposed on the coefficient vector to ensure this behavior holds true:

$$ℒ = [ \begin{matrix}{c}_{0} \\ {λ}_{0}\end{matrix} ] = {arg min}_{c ∈ {ℛ}^{n} , λ ∈ {ℛ}^{1}} {c}^{T} Pc + λ ( {c}^{T} {1}_{n} - 1 ) \qquad ( 3 )$$

Setting the gradient to zero, leads to the following system of equations:

$$∇ ℒ = [ \begin{matrix}\frac{\partial ℒ}{\partial {c}_{0}} \\ \frac{\partial ℒ}{\partial {λ}_{0}}\end{matrix} ] = [ \begin{matrix}2 Pc + λ {1}_{n} \\ {c}^{T} {1}_{n} - 1\end{matrix} ] = [ \begin{matrix}{0}_{n} \\ 0\end{matrix} ] \qquad ( 4 )$$

Next, solve for λ as follows:

$$2 P c = - λ {1}_{n} \qquad ( 5 )$$

$$c = - \frac{λ}{2} {P}^{- 1} {1}_{n} \qquad ( 6 )$$

$${c}^{T} = - \frac{λ}{2} {1}_{n}^{T} {P}^{- 1} \qquad ( 7 )$$

$${c}^{T} {1}_{n} = - \frac{λ}{2} {1}_{n}^{T} {P}^{- 1} {1}_{n} = 1 \qquad ( 8 )$$

$$∴ λ = - \frac{2 {c}^{T} {1}_{n}}{{1}_{n}^{T} {P}^{- 1} {1}_{n}} = - \frac{2}{{1}_{n}^{T} {P}^{- 1} {1}_{n}} \qquad ( 9 )$$

And solve for c using the other equation:

$$2 P c + λ {1}_{n} = {0}_{n} \qquad ( 10 )$$

$$2 Pc - \frac{{2}_{n}}{{1}_{n}^{T} {P}^{- 1} {1}_{n}} = {0}_{n} \qquad ( 11 )$$

$$2 Pc = \frac{{2}_{n}}{{1}_{n}^{T} {P}^{- 1} {1}_{n}} \qquad ( 12 )$$

$$∴ c = \frac{{P}^{- 1} {1}_{n}}{{1}_{n}^{T} {P}^{- 1} {1}_{n}} \qquad ( 13 )$$

Thus, equation (13) enables calculation of coefficients that satisfy the constraints above.

This algorithm can be made iterative in a number of contexts.
1. At calibration time, the profile steps are randomized to prevent order dependencies.
2. Measurements can be fed into the algorithm iteratively by using a complementary filter:

$$c [ t ] = c [ t - 1 ] + α ( {c}^{+} - {c}^{-} ) \qquad ( 14 )$$

In a real-time context, simply updating the coefficients can induce bias and discontinuities in the data, which introduces a requirement that the coefficients evolve “slowly”.

It is recommended to account for health checks and built-in tests in the event of sensor failure or sensor dropout. To enforce this condition, it is enough to simply modify the coefficient before estimation. For instance, if sensor L reports a real-time failure, the covariance matrix can simply be modified by setting the diagonal to an extremely high number compared to other values in the covariance matrix and setting all off-diagonal terms to zero:

$$P = [ \begin{matrix}{σ}_{11}^{2} & … & 0 & … & {σ}_{1 n}^{2} \\ ⋮ & ⋱ & ⋮ & ⋱ & ⋮ \\ 0 & … & ∞ & … & 0 \\ ⋮ & ⋱ & ⋮ & ⋱ & ⋮ \\ {σ}_{n 1}^{2} & … & 0 & … & {σ}_{nn}^{2}\end{matrix} ] \qquad ( 15 )$$

Embodiment of System with Real-Time Updates to Blending Coefficients

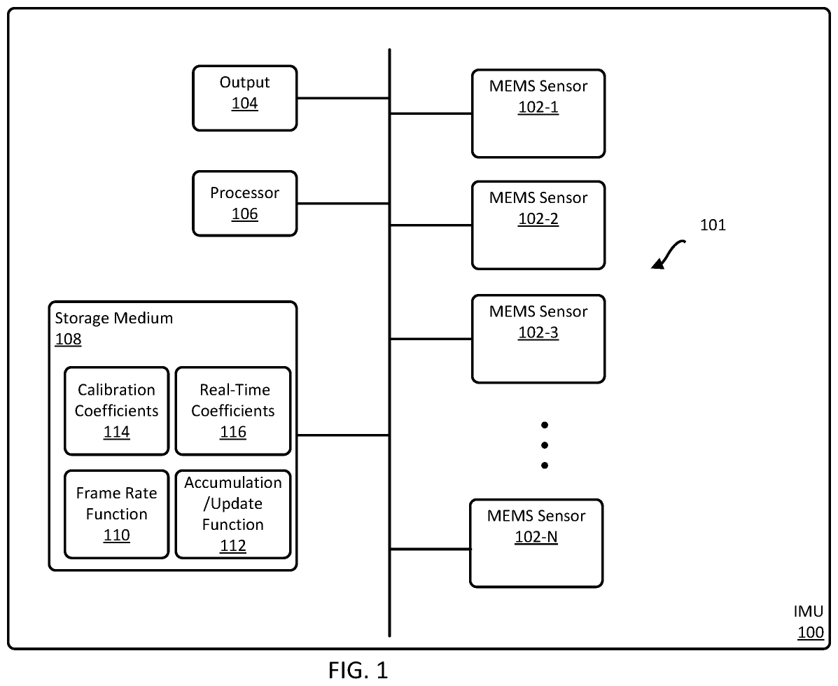

FIG. 1 is a block diagram of one embodiment of an inertial measurement unit (IMU) 100 that implements the teachings laid out above. IMU 100 includes an array 101 of micro-electromechanical system (MEMS) sensors 102-1 to 102-N. Additionally, IMU 100 includes processor 106, storage medium 108 and output 104. Processor 106 is coupled to output 104, storage medium 108, and array 101 of MEMS sensors 102-1 to 102-N. Processor 106 may be implemented using one or more processors, a field programmable gate array (FPGA), an application specific integrated circuit (ASIC), a controller or other circuit used to execute instructions in an electronic circuit. Storage medium 108 can include any available storage media (or computer-readable medium) that can be accessed by a general purpose or special purpose computer or processor, or any programmable logic device. Suitable computer readable media may include storage or memory media such as semiconductor, magnetic, and/or optical media, and may be embodied as a program product comprising instructions stored in non-transitory computer readable media, such as random access memory (RAM), read-only memory (ROM), non-volatile RAM, electrically-erasable programmable ROM, flash memory, or other storage media. Processor 106 uses data and instructions from storage medium 108 to fuse or blend the outputs of the MEMS sensors 102-1 to 102-N to provide a virtual output at output 104 for IMU 100.

IMU 100 produces the virtual output at output 104 using, at least in part, one or more sets of coefficients that determine the contribution of each of the MEMS sensors 102-1 to 102-N to the virtual output. In at least one embodiment, IMU 100 uses two sets of coefficients to produce the virtual output. A first set of coefficients is determined at the time of calibration of the IMU 100. These coefficients are referred to herein as the “calibration coefficients” 114 and are stored in storage medium 108. A second set of coefficients is also employed in this embodiment. This second set of coefficients is updated in real-time during use of IMU 100 and are referred to herein as “real-time coefficients” 116. These real-time coefficients 116 account for changing circumstances, e.g., (1) failure of a sensor and (2) the relative performance of each of the sensors in the array 101. In other embodiments, IMU 100 may use only real-time coefficients 116.

In operation, processor 106 receives outputs from each of the MEMS sensors 102-1 to 102-N. Additionally, processor 106 applies calibration coefficients 114 and real-time coefficients 116 stored on storage medium 108 to the outputs of the MEMS sensors 102-1 to 102-N to dynamically produce the virtual or blended output at output 104.

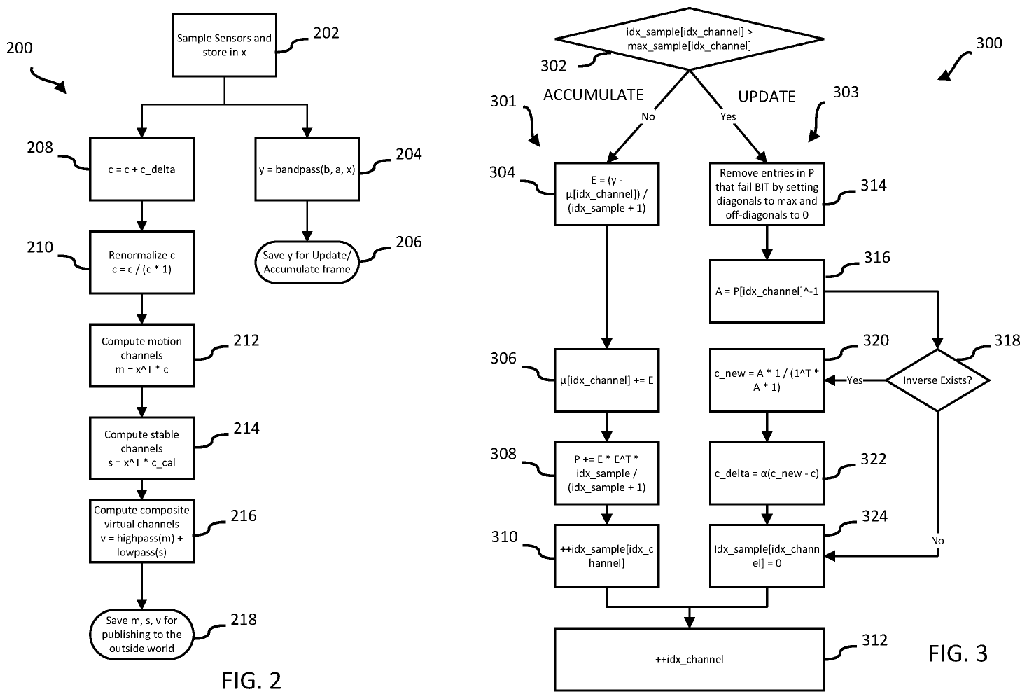

Additionally, processor 106 executes program instructions in frame rate function 110 and accumulation/update function 112 (collectively “blending instructions) which cause processor 106 to calculate real-time coefficients 116 to enable adjustment to the blending of the outputs of the MEMS sensors 102-1 to 102-N in real-time during operation of IMU 100. Embodiments of frame rate function 110 and accumulation/update function 112 are shown in FIG. 2 and FIG. 3, respectively, and are described in more detail below.

During operation, IMU 100 determines if any sensor has failed as part of accumulation/update function 112. For example, in some embodiments, accumulation/update function 112 periodically runs built-in tests that determine if each MEMS sensor 102-1 to 102-N is functioning normally. If any sensor in array 101 of MEMS sensors 102-1 to 102-N is determined to not be functioning normally, then the sensor is flagged as “failed” and is effectively removed from array 101 by adjusting the real-time coefficient for the failed sensor.

IMU 100 also tracks the relative performance of the MEMS sensors in array 101 that have not failed as part of accumulation/update function 112. Based on this monitoring, the real-time coefficients for the MEMS sensors 102-1 to 102-N are also updated dynamically. In some embodiments, the monitoring uses a covariance matrix for IMU 100 that is updated based on data sampled from the MEMS sensors 102-1 to 102-N during operation of IMU 100. From the covariance matrix, IMU 100 calculates adjustments to the rea-time coefficients that are used to calculate the virtual output of IMU 100.

Embodiment of Processes for IMU with Blending Coefficients Updated in Real-Time

FIG. 2 and FIG. 3 are flow charts that illustrate embodiments of processes for dynamically generating and using the real-time coefficients to produce the virtual output of IMU 100. These flow charts illustrate embodiments of two processes that operate at different rates. The two processes are examples of frame rate function 110 and accumulation/update function 112 of FIG. 1. The first process (FIG. 2) samples the data from the sensors and produces the virtual output of the IMU 100 at a first rate (e.g., a frame rate or the rate at which data is provided by the sensors). The second process (FIG. 3) uses the samples from the first process to accumulate data at a second rate (accumulate rate) and to compute data to update the real-time coefficients at a third rate (an update rate). The particular rates selected for the first rate, the second rate and the third rate are based on the system and software architecture of the IMU. Each of these processes are described in turn below.

The processes of FIG. 2 and FIG. 3 rely on a number of tunable parameters which are discussed briefly here, prior to describing the details of the flow of the two processes. Specifically, the following hyperparameters used in the two processes may be tuned to meet the needs of a specific application:
1. a: The fusion ratio (scalar) or the rate at which c_delta is merged into the real-time coefficients. (see block 322, FIG. 3).
2. b_{bandpass}, a_{bandpass}: the bandpass filter coefficients (see block 204, FIG. 2).
3. b_{complementary}, a_{complementary}: the complementary filter coefficients (see block 216). It is noted that, in the embodiment of FIG. 2, the complementary filter is implemented as the linear combination of a high pass filter and a low pass filter which produces a gain of 1 for all frequencies. Further, because a cross-over frequency for the complementary filter, separate coefficients are not needed for the high pass and low pass filters.
4. Nₛₐₘₚₗₑ: Number of samples to accumulate before a coefficient update (referred to a max_sample[idx_channel] in block 302).
5. f_{update}: Frequency at which coefficient updates occur (see second branch 303).
6. f_{accumulate}: Frequency at which P and μ are updated (see first branch 301).

There are many ways to tune this algorithm. In one embodiment, the hyperparameters are tuned as follows:
1. Select f_{update} and f_{accumulate} based on knowledge of the process loading and architecture. These two frequencies could occur at the same rate, or at different rates. The bandpass filter will take care of framing differences and reduce the need for these updates and accumulation steps to occur often.
2. Select b_{bandpass} and a_{bandpass} to highlight timescales that are associated with the system architecture. For instance, the standard calculation for random walk (a type of error characteristic of a MEMs sensor) heavily emphasizes the 1-second timescale. It may be appropriate to select a pass band of approximately 1 second (or 1 Hz). Additionally, at longer time scales, the data from the sensors trends to the calibrated coefficients. Therefore, the bandpass coefficients should be selected such that the pass band is much greater than the cutoff frequency for the complementary filter (see block 216).
3. Emphasizing the 1 second time scale leads to a number of design tradeoffs for the bandpass filter regarding how steep the roll-off needs to be and how wide the pass band needs to be. A good starting point for this would be to generate coefficients using the following MATLAB command:

$$[ b , a ] = cheby 2 ( 1 , 8 , 2 / data\_rate . * [ 1 / 2 , 2 ] , {}^{′} {bandpass}^{′} ) ; \qquad ( 15 )$$

4. Select b_{complementary} and a complementary based upon two conditions:
   a. The cutoff frequency should be significantly greater than the pass band frequency for the bandpass filter so as not to interfere with this filter.
   b. The cutoff frequency should be selected such that the lowpass component contains important and stable long-term information.
A recommended starting point is to design b_{complementary} and a_{complementary} with a first-order complementary butterworth filter, and a cutoff frequency of 1/100 [Hz]. For example, the MATLAB command for generating these coefficients is:

$$[ b , a ] = butter ( 1 , 2 / data\_rate / 100 , ‘ low ’ ) ; \qquad ( 16 )$$

5. Select Nₛₐₘₚₗₑ such that the number of samples yields a stable covariance matrix. The Unscented transform uses 2n+1 samples, where n is the number of diagonal entries (or sensors in the system). For stabler results, increase this count at the cost of latency when updating coefficient estimates.
6. Select the scalar, α, such that the coefficients do not produce discontinuities in the solution. Selecting α such that

$$\frac{{f}_{update}}{{f}_{frame}} ≫ α$$

is a good choice for long term stability, as this ensures the coefficients are never fully update the coefficients before a new estimate is produced. Note that if α=0, the coefficients will never update, but if α=1, the coefficients will be immediately replaced with the new value. Anything between 0 and 1 will result in the current coefficient being updated by a percentage of the updated value.

### A. Embodiment of Process Carried Out at Frame Rate

FIG. 2 is a flow chart that illustrates one embodiment of a process 200 for receiving outputs of a plurality of sensors at a frame rate. In one embodiment, the frame rate is approximately 4,000 Hz. In other embodiments, the frame rate is selected to be another appropriate rate, e.g., a rate selected based on the rate at which data is produced by the array of sensors. In this embodiment, process 200 produces filtered data for use in calculating real-time changes to blending coefficients for the IMU, e.g., IMU 100 of FIG. 1, and applies the blending coefficients, updated in real-time, to the output of the plurality of sensors, e.g., MEMS sensors 102-1 to 102-N of IMU 100, to provide a blended output for the IMU.

Process 200 begins at block 202 by sampling data from the plurality of sensors, e.g., MEMS sensors 102-1 to 102-M. It is noted that each of the MEMS sensors, in one embodiment, includes at least three accelerometers and three gyroscopes with one accelerometer and one gyroscope oriented along one of three sense axes. In one embodiment, each accelerometer and each gyroscope is referred to as a channel herein. In this embodiment, the samples are stored in a vector x for each channel.

At block 204, process 200 applies a bandpass filter to the data in each vector x and stores the result in a corresponding vector y. In one embodiment, the bandpass filter function uses coefficients a and b, discussed above, to apply an appropriate bandpass filter with selected roll-off and pass band. At block 206, process 200 saves the vector y for each channel and makes the vectors available to process 300, described below.

Process 200 also produces the virtual output for the IMU, e.g., IMU 100 of FIG. 1. Process 200 uses real-time coefficients, at least in part, to calculate the virtual output of the IMU. A vector, c, contains the current value of the real-time coefficients for a channel. Additionally, the process 300 of FIG. 3 provides a vector, c_delta, for the channel to process 200 that includes changes to each of the real-time coefficients. At block 208, process 200 applies these changes to the to the vector, c, by adding the changes in vector c_delta to corresponding current values of the real-time coefficients in vector c. At block 210, the values in vector c are renormalized (so that the values in c sum to equal 1).

Process 200 calculates a number of outputs for the IMU at blocks 212, 214, and 216. At block 212, process 200 calculates the “motion channels” (m) for the IMU. To do this, process 200 multiplies the current sample in vector x from each of the plurality of sensors for each channel by the corresponding real-time coefficients in vector c for each channel at block 212. The products of the samples and their corresponding real-time coefficients are summed to produce an output for each channel that is referred to as the “motion channels.” The use of real-time coefficients in the motion channels is designed to produce good results with signals that have lower noise over a sufficiently short period of time. At block 214, process 200 calculates the “stable channels” (s) for the IMU. To do this, process 200 multiplies the current samples in the vector x from each of the plurality of sensors for each channel by the corresponding calibration coefficients in vector c_cal. The products of the samples and their corresponding calibration coefficients are summed to produce a value that is referred to as the “stable channels.” The use of the calibration coefficients in the stable channels is designed to withhold good performance over longer time periods to maintain calibration performance. At block 216, the virtual output of the IMU is generated by a combination of the motion channels (m) processed by a high pass filter and the stable channels(s) processed by a low pass filter. It is noted that the combination of the high pass filter and the low pass filter implements a complementary filter as described above.

It is noted that the motion channels aim to optimize the random walk of a sensor (time scale of approximately 1 second for MEMS sensors), while the stable channels are optimized for the best possible calibration performance (time scale of 500 seconds or longer). In this embodiment, the complementary filter time scale is around the 100 second mark, as this gives a nice tradeoff between the 1 second mark for the motion channels and the 500-1000 second mark of the stable channels. Ultimately, the motion channels and the stable channels operate on the same sensor data but each combination of them is optimized and viewed through a different lens.

At block 218, process 200 published the motion channels (m), the stable channels(s), and the virtual output (v).

### B. Embodiment of Process Carried at Update/Accumulation Rate

FIG. 3 is a flow chart that illustrates one embodiment of a process 300 for calculating updates to real-time blending coefficients for an IMU that blends the outputs of an array of sensors. Process 300 includes two branches: first branch 301 and second branch 303. In first branch 301, process 300 accumulates data in a covariance matrix based on processing samples (idx_sample[idx_channel]) from each channel in each sensor in the array of sensors. First branch 301 operates at an accumulation rate. In one embodiment, the accumulation rate is 10 Hertz or other appropriate rate based on the criteria discussed above. In second branch 303, process 300 uses the accumulated data in the covariance matrix from first branch 301 to generate data that is used to update the real-time blending coefficients. Second branch 303 operates at an update rate. In one embodiment, the update rate is a fraction of the accumulation rate based on the number of samples that are processed in the first branch 301 between updates produced in the second branch 303.

In one embodiment, process 300 switches between first branch 301 and second branch 303 when the number of samples processed in the first branch (accumulation) exceeds a maximum (selected) number of samples for a channel (idx_sample[ids_channel]>max_sample[idx_channel]) as determined at block 302. The second (update) branch is executed and process 300 returns to processing data in the first (accumulation) branch.

In first branch 301, a covariance matrix is iteratively updated with data from each of the sensors in the array of sensors of the IMU. This process begins at block 304 where an error vector, E, is used to compute a running mean for each channel of the IMU. Y is a vector that includes the current value for each sensor in the channel (e.g., see description above with respect to block 204 of FIG. 2). μ is a vector that represents the running mean for a channel of the sensors. The error value for each sensor is calculated according to the equation:

$$E = ( y - μ [ idx\_channel ] ) / ( idx\_sample + 1 )$$

At block 306, the μ vector is updated by adding the vector E to the vector μ.

At block 308, the covariance matrix is updated using the error vector, E, according to the equation:

$$P += E * E \hat{} T * idx\_sample / ( idx\_sample + 1 )$$

At block 310, process 300 increments the counter for the number of samples processed for the channel, idx_sample[idx_channel], to reflect that another data sample has been processed for the channel. At block 312, process 300 increments a counter that tracks the current channel being processed.

In second branch 303, process 300 calculates data used to update the real-time coefficients used to blend the outputs of the sensors in the array of sensors of the IMU using the covariance matrix updated in the first branch 301. At block 314, process 300 removes entries in the covariance matrix, P, corresponding to sensors that have been identified as having failed. In one embodiment, the failed sensors are identified by applying a built-in test (BIT). Process 300, in one embodiment, removes the entries corresponding to the failed sensors by setting diagonals associated with the sensors to a maximum value and the off-diagonals associated with the sensors to 0 (see equation (15) above). At block 316, the inverse of the covariance matrix is calculated and stored as matrix A. Because it may not be possible to compute a valid inverse, process 300 determines if an inverse of the covariance matrix exists. If not, process 300 bypasses the process of calculating data used to update the real-time coefficients. If, however, the inverse exists, process 300 calculates the data used to update the real-time coefficients at blocks 320 and 322. At block 320, process 300 implements equation (13) above to calculate the new values for the real-time coefficients. At block 322, process 300 calculates the delta (change in) the real-time coefficients, c_delta, based on equation 14 above. This value, c_delta, is fed to process 200 of FIG. 2 to be used in calculating the updated real-time coefficients to be used in blending the outputs of the sensors in the array of sensors of the IMU.

It is noted that in some embodiments, the calibration coefficients, c_cal, are also updated to remove the impact of failed sensors on the output of the process of FIG. 2 and FIG. 3. In one embodiment, the calibration coefficients associated with any failed sensor could be set to zero. In another embodiment, the calibration coefficients of any failed sensor are updated in a similar manner to the updating of the real time coefficients described above with respect to block 314. Specifically, the error covariance matrix from the calibration routine is saved in the system, e.g., in storage medium 108 of FIG. 1. This covariance matrix can then be modified using the technique described above with respect to equation (15) and the calibration coefficients can be renormalized (like in block 210) to fully remove the impact of the lost sensor(s). This will ensure that a truly optimal solution (in a least-squares sense) is always computed for the stable channels despite the fact that their coefficients are not computed in real-time.

### EXAMPLE EMBODIMENTS

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

Example 1 includes a method of dynamic, real-time generation of a blended output from a plurality of sensors, the method comprising: at a frame rate, periodically storing samples of outputs of the plurality of sensors as stored samples; filtering the stored samples separately for each of the plurality of sensors with a bandpass filter over a time scale characteristic of a type of error for the plurality of sensors to produce filtered samples; storing the filtered samples; at an accumulation rate, iteratively updating a covariance matrix based on the filtered samples until a selected number of filtered samples have been processed, removing data from the covariance matrix for any of the plurality of sensors that have failed; and calculating, based on the covariance matrix, changes to real-time coefficients to be applied to the outputs of each sensor of the plurality of sensors; and at the frame rate, applying the changes to the real-time coefficients; and calculating the blended output for the plurality of sensors based on the real-time coefficients.

Example 2 includes the method of example 1, wherein filtering the stored samples comprises filtering the stored samples with the bandpass filter with a pass band of approximately 1 Hz.

Example 3 includes the method of example 1, wherein filtering the stored samples comprises filtering the stored samples with the bandpass filter with a pass band selected based on the time scale also associated with a characteristic of the plurality of sensors.

Example 4 includes the method of example 3, wherein the pass band is selected based on the time scale associated with random walk.

Example 5 includes the method of any of examples 1 to 4, wherein iteratively updating comprises iteratively updating until 2n+1 filtered samples have been processed, wherein n is a number of sensors in the plurality of sensors.

Example 6 includes the method of any of examples 1 to 5, wherein removing sensors comprises periodically testing each of the plurality of sensors.

Example 7 includes the method of example 6, wherein, when a sensor has failed, setting a diagonal associated with the sensor in the covariance matrix to a high number compared to other values in the covariance matrix and setting off-diagonal terms to zero.

Example 8 includes the method of any of examples 1 to 7, wherein calculating the blended output for the plurality of sensors comprises: calculating a first output using the real-time coefficients; calculating a second output using calibration coefficients; and blending the first output with the second output to provide a blended output for the plurality of sensors.

Example 9 includes the method of example 8, wherein blending the first output with the second output comprises: applying a high pass filter to the first output; applying a low pass filter to the second output; and combining an output of the low pass filter and an output of the high pass filter to produce the blended output for the plurality of sensors.

Example 10 includes the method of any of examples 1 to 9, wherein, after applying the changes to the real-time coefficients, renormalizing the real-time coefficients so that a sum of the real-time coefficients equals one.

Example 11 includes the method of any of examples 1 to 10, wherein calculating changes to the real-time coefficients comprises: calculating a difference between a new set of real-time coefficients and a prior set of real-time coefficients; and multiplying the difference by a scalar, α, to produce a set of changes to the real-time coefficients.

Example 12 includes the method of example 11, wherein the scalar, α, is selected such that: α<<(update rate/frame rate).

Example 13 includes an inertial measurement unit (IMU) comprising: a plurality of micro-electromechanical system sensors (MEMS sensors), each of the plurality of MEMS sensors having an output; a storage medium for storing calibration coefficients separately for each of the plurality of MEMS sensors, real-time coefficients for each of the plurality of MEMS sensors, and data blending instructions for blending the outputs of the plurality of MEMS sensors; and a processor, coupled to the storage medium and the plurality of MEMS sensors, configured to execute program instructions to: filter, at a frame rate, samples output by the plurality of MEMS sensors with a bandpass filter over a time scale characteristic of a type of error for the plurality of MEMS sensors to produce filtered samples; iteratively update a covariance matrix, at an accumulation rate, based on the filtered samples until a selected number of filtered samples have been processed, calculate, based on the covariance matrix, changes to the real-time coefficients to be applied to the output of each MEMS sensor of the plurality of MEMS sensors; apply, at the frame rate, the changes to the real-time coefficients; and calculate a blended output for the plurality of MEMS sensors based on the real-time coefficients.

Example 14 includes the IMU of example 13, further comprising, when one MEMS sensor of the plurality of MEMS sensors fails, setting a diagonal associated with the one MEMS sensor of the plurality of MEMS sensors in the covariance matrix to a high number compared to other values in the covariance matrix and setting off-diagonal terms to zero.

Example 15 includes the IMU of any of examples 13 and 14, wherein calculating the blended output for the plurality of MEMS sensors comprises: calculating a first output using the real-time coefficients; calculating a second output using the calibration coefficients; and blending the first output with the second output to provide a blended output for the plurality of MEMS sensors.

Example 16 includes the IMU of example 15, wherein blending the first output with the second output comprises: applying a high pass filter to the first output; applying a low pass filter to the second output; and combining an output of the low pass filter and an output of the high pass filter to produce the blended output for the plurality of MEMS sensors.

Example 17 includes a program product comprising a non-transitory computer-readable medium on which program instructions configured to be executed by at least one processor are embodied, wherein when executed by the at least one processor, the program instructions cause the at least one processor to perform a method comprising: at a frame rate, periodically storing samples of outputs of a plurality of sensors to produce stored samples; filtering the stored samples separately for each of the plurality of sensors with a bandpass filter over a time scale characteristic of a type of error for the plurality of sensors to produce filtered samples; storing the filtered samples; at an accumulation rate, iteratively updating a covariance matrix based on the filtered samples until a selected number of filtered samples have been processed, removing data from the covariance matrix for any of the plurality of sensors that have failed; and calculating, based on the covariance matrix, changes to real-time coefficients to be applied to the outputs of each sensor of the plurality of sensors; and at the frame rate, applying the changes to the real-time coefficients; and calculating a blended output for the plurality of sensors based on the real-time coefficients.

Example 18 includes the program product of example 17, wherein calculating the blended output for the plurality of sensors comprises: calculating a first output using the real-time coefficients; calculating a second output using calibration coefficients; and blending the first output with the second output to provide a blended output for the plurality of sensors.

Example 19 includes the program product of example 18, wherein blending the first output with the second output comprises: applying a high pass filter to the first output; applying a low pass filter to the second output; and combining an output of the low pass filter and an output of the high pass filter to produce the blended output for the plurality of sensors.

Example 20 includes the program product of any of examples 17 to 19, wherein calculating changes to the real-time coefficients comprises: calculating a difference between a new set of real-time coefficients and a prior set of real-time coefficients; and multiplying the difference by a scalar, α, to produce a set of changes to the real-time coefficients.

What is claimed is:

1. A method of dynamic, real-time generation of a blended output from a plurality of sensors, the method comprising:
at a frame rate,
periodically storing samples of outputs of the plurality of sensors as stored samples;
filtering the stored samples separately for each of the plurality of sensors with a bandpass filter over a time scale characteristic of a type of error for the plurality of sensors to produce filtered samples;
storing the filtered samples;
at an accumulation rate,
iteratively updating a covariance matrix based on the filtered samples until a selected number of filtered samples have been processed,
removing data from the covariance matrix for any of the plurality of sensors that have failed; and
calculating, based on the covariance matrix, changes to real-time coefficients to be applied to the outputs of each sensor of the plurality of sensors; and
at the frame rate,
applying the changes to the real-time coefficients; and
calculating the blended output for the plurality of sensors based on the real-time coefficients.

2. The method of claim 1, wherein filtering the stored samples comprises filtering the stored samples with the bandpass filter with a pass band of approximately 1 Hz.

3. The method of claim 1, wherein filtering the stored samples comprises filtering the stored samples with the bandpass filter with a pass band selected based on the time scale also associated with a characteristic of the plurality of sensors.

4. The method of claim 3, wherein the pass band is selected based on the time scale associated with random walk.

5. The method of claim 1, wherein iteratively updating comprises iteratively updating until 2n+1 filtered samples have been processed, wherein n is a number of sensors in the plurality of sensors.

6. The method of claim 1, wherein removing sensors comprises periodically testing each of the plurality of sensors.

7. The method of claim 6, wherein, when a sensor has failed, setting a diagonal associated with the sensor in the covariance matrix to a high number compared to other values in the covariance matrix and setting off-diagonal terms to zero.

8. The method of claim 1, wherein calculating the blended output for the plurality of sensors comprises:
calculating a first output using the real-time coefficients;
calculating a second output using calibration coefficients; and
blending the first output with the second output to provide a blended output for the plurality of sensors.

9. The method of claim 8, wherein blending the first output with the second output comprises:
applying a high pass filter to the first output;
applying a low pass filter to the second output; and
combining an output of the low pass filter and an output of the high pass filter to produce the blended output for the plurality of sensors.

10. The method of claim 1, wherein, after applying the changes to the real-time coefficients, renormalizing the real-time coefficients so that a sum of the real-time coefficients equals one.

11. The method of claim 1, wherein calculating changes to the real-time coefficients comprises:
calculating a difference between a new set of real-time coefficients and a prior set of real-time coefficients; and
multiplying the difference by a scalar, α, to produce a set of changes to the real-time coefficients.

12. The method of claim 11, wherein the scalar, α, is selected such that:
α<<(update rate/frame rate).

13. An inertial measurement unit (IMU) comprising:
a plurality of micro-electromechanical system sensors (MEMS sensors), each of the plurality of MEMS sensors having an output;
a storage medium for storing calibration coefficients separately for each of the plurality of MEMS sensors, real-time coefficients for each of the plurality of MEMS sensors, and data blending instructions for blending the outputs of the plurality of MEMS sensors; and
a processor, coupled to the storage medium and the plurality of MEMS sensors, configured to execute program instructions to:
filter, at a frame rate, samples output by the plurality of MEMS sensors with a bandpass filter over a time scale characteristic of a type of error for the plurality of MEMS sensors to produce filtered samples;
iteratively update a covariance matrix, at an accumulation rate, based on the filtered samples until a selected number of filtered samples have been processed,
calculate, based on the covariance matrix, changes to the real-time coefficients to be applied to the output of each MEMS sensor of the plurality of MEMS sensors;
apply, at the frame rate, the changes to the real-time coefficients; and
calculate a blended output for the plurality of MEMS sensors based on the real-time coefficients.

14. The IMU of claim 13, further comprising, when one MEMS sensor of the plurality of MEMS sensors fails, setting a diagonal associated with the one MEMS sensor of the plurality of MEMS sensors in the covariance matrix to a high number compared to other values in the covariance matrix and setting off-diagonal terms to zero.

15. The IMU of claim 13, wherein calculating the blended output for the plurality of MEMS sensors comprises:
calculating a first output using the real-time coefficients;
calculating a second output using the calibration coefficients; and
blending the first output with the second output to provide a blended output for the plurality of MEMS sensors.

16. The IMU of claim 15, wherein blending the first output with the second output comprises:
applying a high pass filter to the first output;
applying a low pass filter to the second output; and
combining an output of the low pass filter and an output of the high pass filter to produce the blended output for the plurality of MEMS sensors.

17. A program product comprising a non-transitory computer-readable medium on which program instructions configured to be executed by at least one processor are embodied, wherein when executed by the at least one processor, the program instructions cause the at least one processor to perform a method comprising:
at a frame rate,
periodically storing samples of outputs of a plurality of sensors to produce stored samples;
filtering the stored samples separately for each of the plurality of sensors with a bandpass filter over a time scale characteristic of a type of error for the plurality of sensors to produce filtered samples;
storing the filtered samples;
at an accumulation rate,
iteratively updating a covariance matrix based on the filtered samples until a selected number of filtered samples have been processed,
removing data from the covariance matrix for any of the plurality of sensors that have failed; and
calculating, based on the covariance matrix, changes to real-time coefficients to be applied to the outputs of each sensor of the plurality of sensors; and
at the frame rate,
applying the changes to the real-time coefficients; and
calculating a blended output for the plurality of sensors based on the real-time coefficients.

18. The program product of claim 17, wherein calculating the blended output for the plurality of sensors comprises:
calculating a first output using the real-time coefficients;
calculating a second output using calibration coefficients; and
blending the first output with the second output to provide a blended output for the plurality of sensors.

19. The program product of claim 18, wherein blending the first output with the second output comprises:
applying a high pass filter to the first output;
applying a low pass filter to the second output; and
combining an output of the low pass filter and an output of the high pass filter to produce the blended output for the plurality of sensors.

20. The program product of claim 17, wherein calculating changes to the real-time coefficients comprises:
calculating a difference between a new set of real-time coefficients and a prior set of real-time coefficients; and
multiplying the difference by a scalar, α, to produce a set of changes to the real-time coefficients.
